(19) United States
(12) Patent Application Publication
(10) Pub. No.: US 2025/0118457 A1
(43) Pub. Date: Apr. 10, 2025

(54) CABLE

(71) Applicants: Fuyu Electronic Technology (Huai'an) Co., Ltd., Huai'an (CN); FOXCONN INTERCONNECT TECHNOLOGY LIMITED, Grand Cayman (KY)

(72) Inventors: A-NAN YANG, Huaian (CN); Han-Run Xie, Huaian (CN); Lu-Yu Chang, New Taipei (TW)

(21) Appl. No.: 18/900,919

(22) Filed: Sep. 30, 2024

(30) Foreign Application Priority Data
Oct. 5, 2023 (CN) 202322665919.X

(51) Int. Cl. H01B 7/282; H01B 7/02; H01B 7/18; H01B 11/00

(52) U.S. Cl. CPC H01B 7/282; H01B 7/0216; H01B 7/0241; H01B 7/1805; H01B 11/002

(57) ABSTRACT

A cable includes: a core wire; a shielding layer covering the core wire; an insulating layer covering the shielding layer; and an outer layer covering the insulating layer; wherein the outer layer is an insulating paint.

### BACKGROUND OF THE INVENTION

### Field of the Invention

The present invention relates generally to a cable used to transmit high frequency signals.

### Description of Related Arts

CN Patent No. 211455347U discloses a cable comprising a pair of core wires, a shielding layer covering the pair of core wires, an insulating layer covering the shielding layer, and an outer layer covering the insulating layer. The material of the insulating layer and the outer layer are PET. The insulating layer is wrapped around the shielding layer in a spiral winding way. The outer layer is wrapped around the insulating layer in a spiral winding way. The insulating layer and the outer layer are wrapped to form a wrapping interface. Moisture and air can easily enter from the wrapping interface and come into contact with the shielding layer, causing oxidation of the shielding layer and thus affecting the shielding performance of the cable.

Therefore, it is necessary to provide a cable with good moisture-proof performance and stable signal transmission.

### SUMMARY OF THE INVENTION

A main object of the present invention is to provide a cable with good moisture-proof performance and stable signal transmission.

To achieve the above object, a cable includes: a core wire; a shielding layer covering the core wire; an insulating layer covering the shielding layer; and an outer layer covering the insulating layer; wherein the outer layer is an insulating paint.

Compared to prior art, the cable of the present invention uses insulating paint as the outer layer so that the cable has better moisture-proof performance, more reliable signal transmission and lower cost.

### BRIEF DESCRIPTION OF THE DRAWING

FIG. 1 is a cross-sectional view of a cable of the present invention.

### DETAILED DESCRIPTION OF THE PREFERRED EMBODIMENT

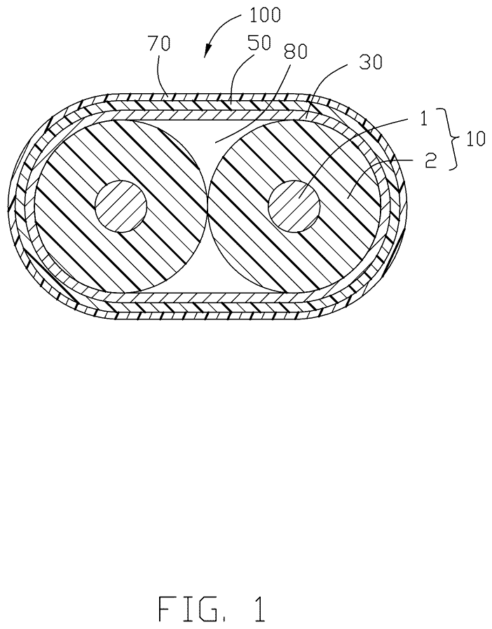

Referring to FIG. 1, a cable 100 of the present invention is shown. The cable 100 includes a core wire 10, a shielding layer 30 covering the core wire 10, an insulating layer 50 covering the shielding layer 30, and an outer layer 70 covering the insulating layer 50.

The core wire 10 includes a pair. The pair of the core wires 10 are arranged side by side longitudinally and in contact with each other. Each of the core wires 10 includes an inner conductor 1 and an inner insulating layer 2 covering the inner conductor 1 by extrusion molding. The inner conductor 1 is used to transmit high-speed signals. The shielding layer 30 is used to eliminate or reduce external electromagnetic interference and prevent leakage of transmission signals. The shielding layer 30 is aluminum-coated PET or copper-coated PET. The shielding layer 30 is wrapped around the pair of core wires 10 in a spiral winding way or a longitudinal wrapping way. The metal layer of the shielding layer 30 is arranged outward to facilitate subsequent cable assembly, such as soldering and grounding, etc. Two air gaps 80 are formed on the upper and lower sides between the shielding layer 30 and the core wire 10. The insulating layer 50 is made of PET (polyethylene terephthalate) tape. The insulating layer 50 is wrapped around the shielding layer 30 in a spiral winding way. The thickness of the insulating layer 50 is 9 to 25 u″. Specifically, the thickness of the insulating layer 50 is 11 u″. The outer layer 70 is made of insulating paint. Different cables can use different colors of insulating paint to facilitate easy identification when multiple cables are assembled. The insulating paint is hot melted and then coated on the insulating layer 50. The cable 100 has no ground wire. The insulating paint covers the wrapping interface of the insulating layer 50 to isolate air and moisture, thereby preventing the metal of the shielding layer from oxidizing. The thickness of the insulating paint is 1 to 20 u″. Specifically, the thickness of the insulating paint is 2 u″. In production and manufacturing, film thickness units generally use micrometers um or microinches μ″ (1 μ″=0.0254 μm).

The outer layer 70 can also be covered with an insulating material in an extrusion molding manner on the outside of the insulating layer 50 to isolate air and moisture. However, in actual production, due to limitations in the production process and technical level, the thickness of the extruded outer layer is approximately 9 to 25 u″. The outer layer 70 of the cable of the present invention is made of insulating paint, and the thickness can be reduced to 2″, this can make the cable 100 thinner and more flexible. Moreover, the coating speed is faster than the extrusion molding speed, which can reduce manufacturing work time. Moreover, coating can reduce the use of insulating paint, and the price of insulating paint is also cheaper, making the production cost of the cable 100 lower.

The cable 100 of the present invention uses insulating paint as the outer layer 70, so that the cable 100 has better moisture-proof performance, and the cable 100 is smaller in size, more flexible, and requires less manufacturing time. The cable 100 of the present invention has high-speed data transmission capability at a frequency of 80 GHz and above.

1. A cable comprising:
a core wire;
a shielding layer covering the core wire;
an insulating layer covering the shielding layer; and
an outer layer covering the insulating layer; wherein
the outer layer is an insulating paint.

2. The cable as claimed in claim 1, wherein the insulating paint is coated on the insulating layer.

3. The cable as claimed in claim 2, wherein a thickness of the insulating paint is 1 to 20 u″.

4. The cable as claimed in claim 2, wherein a thickness of the insulating paint is 2″.

5. The cable as claimed in claim 1, wherein the core wire is arranged as a pair of core wires in contact with each other.

6. The cable as claimed in claim 5, wherein each of the pair of core wires includes an inner conductor and an inner insulating layer covering the inner conductor by extrusion molding.

7. The cable as claimed in claim 1, wherein the shielding layer is aluminum-coated PET or copper-coated PET.

8. The cable as claimed in claim 7, wherein the metal layer of the shielding layer is arranged outward.

9. The cable as claimed in claim 1, wherein the material of the insulating layer is PET, and the insulating layer wraps the shielding layer in a spiral winding way.

10. The cable as claimed in claim 1, wherein the shielding layer covers the core wire in a spiral winding way or a longitudinal covering way.
